(19) United States
(12) Patent Application Publication
(10) Pub. No.: US 2025/0043106 A1
(43) Pub. Date: Feb. 6, 2025

(54) MELT PROCESSIBLE COMPOSITIONS COMPRISING A NONFLUORINATED POLYMER PROCESSING ADDITIVE AND METHODS OF USE

(71) Applicant: 3M INNOVATIVE PROPERTIES COMPANY, St. Paul, MN (US)

(72) Inventors: Roman I. Vasiliev, Kazan (RU); Chetan P. Jariwala, Woodbury, MN (US); Claude Lavallée, Roseville, MN (US)

(21) Appl. No.: 18/718,174

(22) PCT Filed: Nov. 29, 2022
(86) PCT No.: PCT/IB2022/061540

§ 371 Date: Jun. 10, 2024

(30) Foreign Application Priority Data
Dec. 16, 2021 (RU) 2021137302

(51) Int. Cl. C08K 5/11; C08G 63/668; C08L 23/08

(52) U.S. Cl. CPC C08K 5/11; C08G 63/668; C08L 23/0815; C08L 2205/03

(57) ABSTRACT

Described herein is the use of a non-fluorinated preformed polyester in the melt processing of a non-fluorinated polymer composition, wherein the preformed ester is a product of a polyol and a saturated, aliphatic polyacid.

### TECHNICAL FIELD

The present disclosure relates to the use of a preformed ester in the melt processing of non-fluorinated polymers to reduce and/or eliminate defects in the melt processed product, and/or improve the pressure drop when making the product.

### SUMMARY

Extrusion of polymer materials to obtain and form products is a large segment of the plastic and polymer product industry. The quality of the extruded product (or extrudate) and the overall success of the extrusion process usually depend on the processing conditions and the interaction of the fluent material with the extrusion die.

Processing aids used to stabilize the extrusion process, reduce or eliminate defects, and improve critical machine parameters (like die pressure and motor load/torque) are known and used in the plastics industry. Polymer processing additives (or PPAs) containing fluoropolymers are one of the mostly commonly used solutions, especially for polyolefins processing, because of the unique properties of fluoropolymers and their proven predictable performance. However, there are disadvantages to using fluoropolymer PPA's including, among other things, their high cost and the current trend toward reducing exposure to highly fluorinated products. Thus, there is market demand for new types of fluorine-free processing additives especially in non-woven hygiene and some food package applications.

In one aspect, a melt processible polymer composition is described, the composition comprising: (a) a non-fluorinated melt processible polymer; and (b) an effective amount of a preformed ester to improve melt processing of the melt processible polymer composition, wherein the preformed ester is a product of a polyol and a saturated, aliphatic polyacid, and wherein the melt processible polymer composition is free of a fluoropolymer and a silicone polymer.

In another aspect, a polymer melt additive composition for use as a processing aid in the extrusion of a non-fluorinated melt processible polymer is described. The polymer melt additive composition comprises a preformed ester, wherein the preformed ester is a product of a polyol and a saturated, aliphatic polyacid.

In yet another aspect, a method of forming an extrudate is described. The method comprising: extruding a melt processible polymer composition, wherein the melt processible polymer composition comprises (a) a non-fluorinated melt processible polymer; and (b) an effective amount of a preformed ester to improve melt processing of the melt processible polymer composition, wherein the preformed ester is a product of a polyol and a saturated, aliphatic polyacid, and wherein the melt processible polymer composition is free of a fluoropolymer and a silicone polymer.

The above summary is not intended to describe each embodiment. The details of one or more embodiments of the invention are also set forth in the description below. Other features, objects, and advantages will be apparent from the description and from the claims.

### DETAILED DESCRIPTION

As used herein, the term
“a”, “an”, and “the” are used interchangeably and mean one or more.
“and/or” is used to indicate one or both stated cases may occur, for example A and/or B includes, (A and B) and (A or B);
“alkyl” means a linear or branched, cyclic or acyclic, saturated monovalent hydrocarbon having from one to about twelve carbon atoms, e.g., methyl, ethyl, 1-propyl, 2-propyl, pentyl, and the like;
“aryl” means a monovalent aromatic, such as benzyl, phenyl, and the like;
“backbone” refers to the main continuous chain of the polymer;
“monomer” is a molecule which can undergo polymerization which then form part of the essential structure of a polymer; and
“polymer” refers to a macrostructure comprising interpolymerized units of monomers.

The singular forms “a”, “an”, and “the” do not refer only to a single object, but include the general class, a specific example of which may be used for illustrative purposes.

As used herein, the term “comprising at least” followed by a list refers to that comprising any one of the listed items and any combination of two or more of the listed items. As used herein, the term “at least one of” followed by a list refers to any of the listed items or to any combination of two or more of the listed items.

As used herein, recitation of ranges by endpoints includes all numbers subsumed within that range (e.g., 1 to 10 includes 1.4, 1.9, 2.33, 5.75, 9.98, etc.).

As used herein, recitation of “at least” followed by a number includes the named number and all those greater. For example, “at least 1” includes all numbers of one and greater (e.g., at least 2, at least 4, at least 6, at least 8, at least 10, at least 25, at least 50, at least 100, etc.).

Extrusion is the process wherein a material, such as a resin, is pushed through a die of a given cross-section. It is generally believed that when the extrusion rate exceeds a certain value, the internal stresses on the resin reach a critical value, where the release of those stress result in deformities or imperfections in the extrudate, polymer buildup at the die aperture (also known as material accumulation at the extrusion die, or sags at the extrusion die), and/or increased back pressure during extrusion. These problems slow down the extrusion process, as the process either has to be interrupted to clean the equipment or has to be performed at a lower rate.

In the present disclosure, it has been discovered that by pre-reacting a polyol with a saturated, aliphatic polyacid to form a polyester, that this polyester can be used as a polymer processing additive to reduce pressure and/or eliminate defects in the processing of a non-fluorinated melt processible polymer.

As used herein, “melt processible” is meant that the respective polymer or composition can be processed in commonly used melt processing equipment such as, for example, an extruder. The melt processible polymer composition disclosed herein can refer to the extruded final form of the composition (such as a pellet, a film, a fiber, a coated wire or cable sheath, etc.) or can refer to a masterbatch (or concentrate), which is diluted with additional polymer (such as a non-fluorinated melt processible polymer) before being extruded.

The preformed ester of the present disclosure is a reaction product of a polyol and a saturated, aliphatic polyacid.

A polyol refers to a polyhydric alcohol containing multiple (i.e., 2 or more) hydroxyl groups. The polyol may comprise at least 2, 3, or even at least 4 hydroxyl groups per molecule. Preferably, the number of hydroxyl groups is 2. Exemplary polymers include polyethylene glycol, polypropylene glycol, polycaprolactone, poloxamers, and polytetrahydrofuran-based glycols.

In one embodiment, the polyol is a diol. Exemplary diols include poly (oxyalkylene) polymers. A class of such poly (oxyalkylene) polymers may be represented by the general formula:

A[(OR³)ₓOR²]_{y}

wherein: A is an active hydrogen-free residue of a low molecular weight, initiator organic compound having a plurality of active hydrogen atoms (e.g., 2 or 3), such as a polyhydroxyalkane or a polyether polyol, e. g., ethylene glycol, glycerol, 1,1,1-trimethylol propane, and poly (oxypropylene) glycol; y is 2 or 3; (OR³)ₓ is a poly (oxyalkylene) chain having a plurality of oxyalkylene groups, OR³ wherein the R³ moieties can be the same or different and are selected from the group consisting of C₁ to C₅ alkylene radicals and, preferably, C₂ or C₃ alkylene radicals, and x is the number of oxyalkylene units in said chain. Said poly (oxyalkylene) chain can be a homopolymer chain, e. g., poly (oxyethylene) or poly (oxypropylene), or can be a chain of randomly distributed (i.e., a heteric mixture) oxyalkylene groups, e. g., a copolymer —OC₂H₄— and —OC₃H₆— units, or can be a chain having alternating blocks or backbone segments of repeating oxyalkylene groups, e. g., a polymer comprising (—OC₂H₄—)ₐ and (—OC₃H₆—)_{b} blocks, wherein a+b=5 to 5000 or higher, or even 10 to 500. R² is H or an organic radical, such as alkyl, aryl, or a combination thereof such as aralkyl or alkaryl, and may contain oxygen or nitrogen heteroatoms. For example, R₂ can be methyl, butyl, phenyl, benzyl, and acyl groups such as acetyl, benzoyl and stearyl.

Poly (oxyalkylene) polyols useful in this invention include polyethylene glycols which can be represented by the formula H(OCH₂CH₂)ₙOH, wherein n is the average number of moles of OCH₂CH₂ groups, ranging from 90 to 455, 100 to 300, or still even 135 to 250. Such polyethylene glycols include those sold by Dow Chemical Co., Midland, MI, under the trade designation “CARBOWAX”, such as “CARBOWAX SENTRY POLYETHYLENE GLYCOL 8000”, where n is 181, and those sold by E.I. du Pont de Nemours Inc., Wilmington, DE under the trade name “POLYOX”, such as “POLYOX WSR N-10” where n is about 2300, e.g. 2272.

In one embodiment, the poly (oxyalkylene) polyol is a polypropylene glycol which can be represented by the formula H[OCH(CH₃)CH₂]ₘOH, wherein m is the average number of moles of OCH(CH₃)CH₂ groups, ranging from 34 to 350, 50 to 300, or even 100 to 250.

In one embodiment of the present disclosure, the polyol is a polycaprolactone polyol. Such polyols are available from Ingevity, North Charleston, SC, under the trade designation “CAPA” or Connect Chemicals USA, LLC, Alpharetta, GA under the trade designation “POLYCAP”.

In one embodiment of the present disclosure, the polyol is a copolymer comprising more than 1 different type of interpolymerized monomeric unit. For example, the polyol may be a poloxamers. A poloxamer is a triblock copolymer comprising a central chain of polyoxypropylene with a chain of polyoxyethylene on both ends. Such poloxamers include those sold by Thermo Fisher Scientific Inc., Waltham, MA, under the trade designation “PLURONIC”, such as “PLURONIC F-127”, which has an approximate molecular weight of 12,500 g/mol, and those sold by Croda Inc., Wilmington, DE under the trade name “SYNPERONIC”, such as “SYNPERONIC PE/F68”. Another example of a polyol is a poly(tetrahydrofuran)-based polyol.

In order to act as a polymer processing additive, the polyol should have a sufficient molecular weight. In one embodiment, the polyol has an average molecular weight of at least 2000, 4000, or even 6000 grams/mole (g/mol). The molecular weight needs to be large enough to yield good performance, but not so large that the molecule has too few of reactive sites based on weight. In one embodiment, the polyol has an average molecular weight of no more than 20,000; 15,000; or even 10,000 g/mol. The number average molecular weight may be measured by Gel Permeation Chromatography (GPC) using polyethylene glycol and poly(ethylene oxide) standards. GPC equipment and standards are available from Agilent Technologies, Inc., Santa Clara, CA

The polyol described above is reacted with a saturated, aliphatic polyacid. The saturated, aliphatic polyacid may be linear, branched, or cyclic and is free of C—C double bonds. The saturated, aliphatic polyacid comprises at least two carboxylic acid groups and may comprise more, for example, at least 3, at least 4, or even at least 5 carboxylic acid groups per molecule.

Exemplary carboxylic acids include: adipic acid, succinic acid, glutaric acid, pimelic acid, suberic acid, azelaic acid, sebacic acid, undecanedioic acid, dodecanedioic acid, tridecanedioic acid, hexadecanedioic acid, citric acid, butane-1,2,3,4-tetracarboxylic acid, C9 to C18 saturated linear aliphatic acids (such as thapsic acid, octadecandioic acid, or azelaic acid), or mixtures thereof.

It has been discovered that pre-reacting the polyol and the saturated, aliphatic polyacid before contact with the non-fluorinated melt processible polymer results in improved manufacture of product, through a larger pressure drop, reduced or eliminated melt fracture, and/or less die buildup.

The polyol and the saturated, aliphatic polyacid are first reacted to form a polyester. Such polycondensation reaction techniques are known in the art.

In one embodiment, the ratio of the saturated, aliphatic polyacid to the hydroxide groups of the polyol when doing the reaction is at least 0.5, 1.0, or even 1.2; and at most 2.0, 1.8, or even 1.5.

After pre-reacting the saturated, aliphatic polyacid to the polyol, the resulting polyester can be solidified. The ester preform composition may be used in the form of a powder, pellet, granule of a desired particulate size or size distribution, or any other extrudable form for presentation to the non-fluorinated melt processible polymer.

The preformed esters provided herein may be used as processing aids for facilitating or improving the quality of the extrusion of non-fluorinated polymers. They can be mixed with non-fluorinated polymers during extrusion into polymer articles. They can also be provided as polymer compositions, so-called masterbatches, which may contain further components and/or one or more host polymers. Typically, master batches contain the polymer processing additive dispersed in or blended with a host polymer, which typically is a non-fluorinated polymer. Masterbatches may also contain further ingredients, such as synergists, lubricants, etc. The masterbatch may be a composition ready to be added to a non-fluorinated polymer for being extruded into a polymer article. The masterbatch may also be a composition that is ready for being directly processed into polymer articles without any further addition of non-fluorinated polymer.

The amount of the preformed ester in these melt processible polymer compositions is typically relatively low. The exact amount used may be varied depending upon whether the extrudable composition is to be extruded into its final form (e.g. a film) or whether it is to be used as a master batch or processing additive which is to be (further) diluted with additional host polymer before being extruded into its final form.

In the present disclosure, an effective amount of the preformed ester is used to improve processing of composition. Generally, the polymer composition comprises from about 0.001 to 30 weight % of the preformed ester. If the melt processible polymer composition is a master batch or processing additive, the amount of preformed ester is typically at least 0.1, 0.2, 0.5, 1.0, 1.5 or even 2%; and at most 20, 15, 10, 8, 6, 5, or even 3% by weight versus the non-fluorinated melt processible polymer. If the melt processible polymer composition is to be extruded into final form and is not further diluted by the addition of host polymer, it typically contains a lower concentration of the preformed ester, e.g., at least 0.001, 0.002, 0.005, 0.01, 0.02, 0.05, or even 0.10%; and at most 2.0, 1.5, 1.0, 0.75, 0.5, 0.4, 0.3, or even 0.2% by weight versus the non-fluorinated melt processible polymer. In any event, the upper concentration of the preformed ester used is generally determined by economic limitations rather than by adverse physical effects of the concentration of the melt processible polymer composition.

The non-fluorinated melt processible polymers used in the melt processible polymer compositions of the present disclosure may be selected from a variety of polymer types. Such polymers include, but are not limited to, hydrocarbon resins, polyamides (including but not limited to nylon 6, nylon 6/6, nylon 6/10, nylon 11, nylon 12, poly(iminoadipolyliminohexamethylene), poly(iminoadipolyliminodecamethylene), and polycaprolactam), polyester (including but not limited to poly (ethylene terephthalate) and poly (butylene terephthalate)), chlorinated polyethylene, polyvinyl resins such as polyvinylchoride, polyacrylates and polymethylacrylates, polycarbonates, polyketones, polyureas, polyimides, polyurethanes, polyolefins and polystyrenes.

The non-fluorinated polymers are melt processible. Typically, the polymers, including hydrocarbon polymers, have melt flow indexes (measured according to ASTM D1238-13 at 190° C., using a 2160 g weight) of 5.0 g/10 minutes or less, preferably 2.0 g/10 minutes. Generally, the melt flow indexes are greater than 0.1 or 0.2 g/10 min.

A particularly useful class of melt processible polymers are hydrocarbon polymers, in particular, polyolefins. Representative examples of useful polyolefins are polyethylene, polypropylene, poly (1-butene), poly (3-methylbutene), poly (4-methylpentene) and copolymers of ethylene with propylene, 1-butene, 1-hexene, 1-octene, 1-decene, 4-methyl-1-pentene, and 1-octadecene.

Representative blends of useful polyolefins include blends of polyethylene and polypropylene, linear or branched low-density polyethylenes (e.g., those having a density of from 0.89 to 0.94 g/cm³), high-density polyethylenes (e.g., those having a density of e.g. from 0.94 to about 0.98 g/cm³), and polyethylene and olefin copolymers containing said copolymerizable monomers, some of which are described below, e. g., ethylene and acrylic acid copolymers; ethylene and methyl acrylate copolymers; ethylene and ethyl acrylate copolymers; ethylene and vinyl acetate copolymers; ethylene, acrylic acid, and ethyl acrylate copolymers; and ethylene, acrylic acid, and vinyl acetate copolymers.

The polyolefins may be obtained by the homopolymerization or copolymerization of olefins, as well as copolymers of one or more olefins and up to about 30 weight percent or more, but preferably 20 weight percent or less, of one or more monomers that are copolymerizable with such olefins, e. g. vinyl ester compounds such as vinyl acetate. The olefins may be characterized by the general structure CH₂═CHR, wherein R is a hydrogen or an alkyl radical, and generally, the alkyl radical contains not more than 10 carbon atoms, preferably from one to six carbon atoms. Representative olefins are ethylene, propylene, 1-butene, 1-hexene, 4-methyl-1-pentene, and 1-octene. Representative monomers that are copolymerizable with the olefins include: vinyl ester monomers such as vinyl acetate, vinyl propionate, vinyl butyrate, vinyl chloroacetate, and vinyl chloropropionate; acrylic and alpha-alkyl acrylic acid monomers and their alkyl esters, amides, and nitriles such as acrylic acid, methacrylic acid, ethacrylic acid, methyl acrylate, ethyl acrylate, N,N-dimethyl acrylamide, methacrylamide, and acrylonitrile; vinyl aryl monomers such as styrene, o-methoxystyrene, p-methoxystyrene, and vinyl naphthalene; vinyl and vinylidene halide monomers such as vinyl chloride, vinylidene chloride, and vinylidene bromide; alkyl ester monomers of maleic and fumaric acid and anhydrides thereof such as dimethyl maleate, diethyl maleate, and maleic anhydride; vinyl alkyl ether monomers such as vinyl methyl ether, vinyl ethyl ether, vinyl isobutyl ether, and 2-chloroethyl vinyl ether; vinyl pyridine monomers; N-vinyl carbazole monomers; and N-vinyl pyrolidine monomers.

The most preferred polymers useful in the present disclosure are hydrocarbon polymers such as homopolymers of ethylene and propylene or copolymers of ethylene and 1-butene, 1-hexene, 1-octene, 4-methyl-1-pentene, propylene, vinyl acetate and methyl acrylate.

The melt processible polymers may be used in the form of powders, pellets, granules, or in any other extrudable form.

The melt processible composition of the present disclosure can be prepared by any of a variety of ways. For example, the melt processible polymer and the preformed ester can be combined together by any of the blending means usually employed in the plastics industry, such as with a compounding mill, a Banbury mixer, or a mixing extruder in which the preformed ester is uniformly distributed throughout the non-fluorinated melt processible polymer. The preformed ester and the non-fluorinated melt processible polymer may be used in the form, for example, of a powder, a pellet, or a granular product. The mixing operation is most conveniently carried out at a temperature above the melting point or softening point of the melt processible polymer, though it is also feasible to dry-blend the components in the solid state as particulates and then cause uniform distribution of the components by feeding the dry blend to a twin-screw melt extruder.

The resulting melt-blended mixture can be pelletized or otherwise comminuted into a desired particulate size or size distribution and fed to an extruder, which typically will be a single-screw extruder, that melt processes the blended mixture. Melt processing typically is performed at a temperature from 180° C. to 280° C., although optimum operating temperatures are selected depending upon the melting point, melt viscosity, and thermal stability of the blend. The melt processible composition of the present disclosure may be extruded using techniques known in the art, such as pellet mill extrusion; ram extrusion; film extrusion; pipe, wire, and cable extrusion; fiber and strand production; etc. Different types of extruders that may be used to extrude the compositions of this invention are described, for example, by Rauwendaal, C., “Polymer Extrusion”, Hansen Publishers, p. 23-48, 1986. The die design of an extruder can vary, depending on the desired extrudate to be fabricated. For example, an annular die can be used to extrude tubing, useful in making fuel line hose, such as that described in U.S. Pat. No. 5,284,184 (Noone et al.), which description is incorporated herein by reference.

In addition to the preformed ester, the melt processible polymer composition can contain conventional adjuvants such as antioxidants, antiblocking agents, light stabilizers (such as hindered amine light stablizers, and ultra violet light stabilizers), metal oxides (such as magnesium oxide and zinc oxide), pigments, and fillers (e.g., titanium dioxide, carbon black, and silica). Antiblocking agents, such as talc, silica (such as diatomaceous earth), and nepheline syenite, when used, may be coated or uncoated materials.

Advantageously, the melt processible polymer compositions of the present disclosure are free of a fluoropolymer and free of a silicone polymer. Often fluoropolymers and/or silicone polymers are used as a processing aid. In the present disclosure, neither fluoropolymers nor silicone polymers are added to the melt processible composition. However, small amounts of these compounds may be detectable in the resulting article, due to contamination of equipment, etc. and the ability to detect very low levels of these compounds, especially fluoropolymers. Thus, the melt processible polymer compositions of the present disclosure are substantially free of fluoropolymer and a silicone polymer. In other words, the melt processible polymer composition comprises less than 0.01, 0.5, 0.001, 0.0005, 0.0001, or even 0.00005% of a fluoropolymer and silicone polymers, or is below the detection limit of the measuring technique. Techniques for detection include those known in the art, such as pyrolysis of the melt-processible composition and fluorine content measurement using ion chromatography or an ion specific electrode.

In one embodiment, the non-fluorinated polymer may typically have a melt flow index (measured according to ASTM D1238-13 with a 2.16 kg weight at 190° C.; or ISO 1133-1:2011 using a 5 kg at 190° C.) of at most 0.5 g/10 minutes. In one embodiment, the non-fluorinated polymer has a melt flow index of at least 0.05, 0.1, 0.15, or even 0.2 g/10 minutes. In one embodiment, the non-fluorinated polymer has a melt flow index of at most 0.3, 0.4, or even 0.5 g/10 minutes.

The melt processible compositions of the present disclosure may be used in articles. In one embodiment, the preform ester-containing polymer composition is useful in the extrusion of non-fluorinated polymers, which includes for example, extrusion of films, extrusion blow molding, injection molding, pipe, wire and cable extrusion, and fiber production.

### EXAMPLES

Unless otherwise noted, all parts, percentages, ratios, etc. in the examples and the rest of the specification are by weight, and all reagents used in the examples were obtained, or are available, from general chemical suppliers such as, for example, Sigma-Aldrich Company, Milwaukee, WI, USA, or known to those skilled in the art, unless otherwise stated or apparent.

The following abbreviations are used in this section: g=grams, mmole=millimole, kg=kilograms, cc=cubic centimeter, min=minutes, mm=millimeters, ppm=parts per million, s=seconds, RPM=revolutions per minute, ° C.=degrees Celsius, Pa=pascal, MFI=melt flow index and MFR=melt flow rate. Abbreviations for materials used in this section, as well as descriptions of the materials, are provided in Table 1.

TABLE 1
Materials

| Material | Details |
|---|---|
| RESIN 1 | Linear Low Density Polyethylene resin trade designation SABIC |
| | 118NJ, available from Sabic, Saudi Arabia. |
| | Density 918 kg/m³ ASTM D1505 |
| | Melt Flow Rate at 190° C. and 2.16 kg 1 g/10 min ASTM D1238 |
| RESIN 2 | Linear Low Density Polyethylene resin trade designation SABIC |
| | 318BJ, available from Sabic, Saudi Arabia. |
| | Density 918 kg/m³ ASTM D1505 |
| | Melt Flow Rate at 190° C. and 2.16 kg 2.8 g/10 min ASTM D1238 |
| Succinic Acid | Succinic acid, laboratory grade, from Reachem, Mississsuaga, Canada |
| Citric Acid | Citric acid from Reachem, laboratory grade |
| Irganox 1024 MD | Bis(3,5-di-tert-butyl-4-hydroxyhydrocinnamoyl)hydrazine available |
| | under the trade designation IRGANOX MD 1024 from BASF |
| Ti(BuO)4 | Titanium butoxide available from Sigma-Aldrich Company |
| PEG | Polyethylene glycol (Mw = 8000 g/mole) available under the trade |
| | designation PEG-8000 from Norchem, Russia |

### Preformed Ester Preparation Method

For EX-1, 1.3 g (11 mmole, Mw=118.07 g/mole of succinic acid was added to 40 g (5 mmole) of PEG (10% excess 1:2 (PEG:acid) molar ratio) and then was heated at 175-180 under inert atmosphere for 30 min followed by addition of 1 drop (about 0.02 g, about 0.05-0.06 mmole, Mw=340.36 g/mole) of Ti(BuO)4. Mixture than was allowed to stir while heating for 4 hours, then 0.04 g, (about 0.07 mmole, Mw=556 g/mole) of Irganox 1024 MD was added, stirred for additional 10 min and the viscous reaction mass was transferred onto aluminum foil. After solidifying, the additive was crushed and used in the Masterbatch Preparation Method below

For EX-2, the procedure described for EX-1 was followed with the exception that 2.1 g of citric acid was used in place of the succinic acid, representing a PEG:acid molar ratio of 1:2 with 10% excess of the acid.

### Masterbatch Preparation Method

3% by weight masterbatches were prepared on batch mixer (Plasti-Corder, Brabender GmbH & Co KG) in the RESIN 2 base. For EX-1, and EX-2, mixing conditions were: 180° C. at 80 RPM with 5 min mixing. For CE-1, and CE-2, polyol and polyacid were blended in a molar ratio of 1:2 with 10% excess of the acid in the resin and mixed at 180° C. at 80 RPM for 2 min. For CE-3, PEG was added and the sample was blended with the resin at 180° C. at 80 RPM for 2 min.

### Extrusion and Rheology Measurements

Melt processible polymer compositions were extruded after RESIN 1 was combined with additives, if used, as indicated in Table 3 using a single screw rheology extruder (Lab Station, Brabender GmbH & Co KG, Duisburg, Germany), with round capillary die (2×30 mm). The temperature profile applied in the zones of the extruder was as indicated in Table 2. Then extruder ran at constant 25 RPM (about 400 s⁻¹) until a stable pressure level for the RESIN 1 was reached. After that additives were added to a concentration of 300 ppm via 3% by weight masterbatches in the premix of corresponding masterbatch with RESIN 1. Pressure changes (drop and/or stabilization) and changing the strand surface quality was evaluated starting immediately after additives were in premix. The pressure drop was determined as follows: 100%−[(final pressure x 100%)/initial pressure]. Shear rate and RPM during stabilization time was kept constant (25 RPM/about 400 s⁻¹). All tested additives gave high quality dispersion in the resin as observed by optical microscopy. Strand surface was rated according to the following criteria: 1) gross melt fracture, 2) no observed gross melt fracture. The extruder was cleaned between melt processible polymer compositions by extruding antiblock masterbatch (comprising 50 wt % of natural silica in linear low density polyethylene) to achieve a pressure level that was the same as pure material without additive.

TABLE 2
Extruder temperature profile

| Zone 1 | Zone 2 | Zone 3 | Zone 4 | Zone 5, |
|---|---|---|---|---|
| (° C.) | (° C.) | (° C.) | (° C.) | die (° C.) |
| 160 | 180 | 195 | 210 | 220 |

TABLE 3
Characterization

| Example or | | | | Strand surface | Full elimination | Level of Pressure |
|---|---|---|---|---|---|---|
| Comparative | | | | quality after | of defects on | drop after |
| Example | Polyol | Polyacid | Preparation | 60 min | strand, at min | stabilization, % |
| EX-1 | PEG | Succinic acid | Reacted | Partial MF | No | 18 |
| CE-1 | PEG | Succinic acid | Mixed | Full MF | No | 4 |
| EX-2 | PEG | Citric acid | Reacted | No MF | 50 | 18 |
| CE-2 | PEG | Citric acid | Mixed | Partial MF | No | 11 |
| CE-3 | PEG | — | — | Full MF | No | 4 |

Foreseeable modifications and alterations of this invention will be apparent to those skilled in the art without departing from the scope and spirit of this invention. This invention should not be restricted to the embodiments that are set forth in this application for illustrative purposes. To the extent that there is any conflict or discrepancy between this specification as written and the disclosure in any document mentioned or incorporated by reference herein, this specification as written will prevail.

1. A melt processible polymer composition comprising:
a non-fluorinated melt processible polymer; and
an effective amount of a preformed ester to improve melt processing of the melt processible polymer composition, wherein the preformed ester is a product of a polyol and a saturated, aliphatic polyacid,
wherein the melt processible polymer composition is substantially free of a fluoropolymer and a silicone polymer.

2. The melt processible polymer composition of claim 1, wherein the polyol has an average molecular weight of at least 2000 g/mol.

3. The melt processible polymer composition of claim 1, wherein the polyol is polyethylene glycol, polypropylene glycol, polycaprolactone, a poloxamer, a polytetrahydrofuran-based glycol, or mixtures thereof.

4. The melt processible polymer composition of claim 1, wherein the polyol is of the formula H—[OCH₂CH₂]ₙ—OH, wherein n is the average number of moles of OCH₂CH₂ groups, ranging from 90 to 455.

5. The melt processible polymer composition of claim 1, wherein the saturated, aliphatic polyacid is one of: adipic acid, succinic acid, glutaric acid, pimelic acid, suberic acid, azelaic acid, sebacic acid, undecanedioic acid, dodecanedioic acid, tridecanedioic acid, hexadecanedioic acid, citric acid, butane-1,2,3,4-tetracarboxylic acid, C9 to C18 diacids, or mixtures thereof.

6. The melt processible polymer composition of claim 1, wherein the saturated, aliphatic polyacid comprises at least 3 carboxylic acid groups.

7. The melt processible polymer composition of claim 1, wherein the polyol comprises a plurality of hydroxide groups, and wherein the ratio of the saturated, aliphatic polyacid to the hydroxide groups is at least 0.5 and at most 2.

8. The melt processible polymer composition of claim 1, wherein the saturated, aliphatic polyacid comprises a plurality of acid groups, and wherein the ratio of the polyol to the acid groups is at least 0.5 and at most 2.

9. The melt processible polymer composition of claim 1, wherein the non-fluorinated melt processible polymer comprises at least one of polypropylene, polyethylene, and combinations thereof.

10. The melt processible polymer composition of claim 1, the melt processible polymer composition comprising 0.1 to 20% by weight of the preformed ester versus the non-fluorinated melt processible polymer.

11. The melt processible polymer composition of claim 1, the melt processible polymer composition comprising 0.001 to 1% by weight of the preformed ester versus the non-fluorinated melt processible polymer.

12. The melt processible polymer composition of claim 1, wherein the melt processible polymer composition comprises a third polymer, optionally wherein the melt processible polymer composition comprises less than 50% by weight of a third polymer.

13. The melt processible polymer composition of claim 1, wherein the melt processible polymer composition is extrudable.

14. (canceled)

15. (canceled)

16. (canceled)

17. A polymer melt additive composition for use as a processing aid in the extrusion of a non-fluorinated melt processible polymer, the polymer melt additive composition comprising a preformed ester, wherein the preformed ester is a product of a polyol and a saturated, aliphatic polyacid.

18. The polymer melt additive composition of claim 17, wherein the polyol has an average molecular weight of at least 2000 g/mol.

19. The polymer melt additive composition of claim 17, wherein the polyol is polyethylene glycol, polypropylene glycol, polycaprolactone, a poloxamer, a polytetrahydrofuran-based glycol, or mixtures thereof.

20. The polymer melt additive composition of claim 17, wherein the polyol is of the formula H—[OCH₂CH₂]ₙ—OH, wherein n is the average number of moles of OCH₂CH₂ groups, ranging from 90 to 455.

21. The polymer melt additive composition of claim 17, wherein the saturated, aliphatic polyacid is adipic acid, succinic acid, glutaric acid, adipic acid, pimelic acid, suberic acid, azelaic acid, sebacic acid, undecanedioic acid, dodecanedioic acid, tridecanedioic acid, hexadecanedioic acid, citric acid, butane-1,2,3,4-tetracarboxylic acid, C9 to C18 diacids, or mixtures thereof.

22. (canceled)

23. (canceled)

24. The polymer melt additive composition of claim 17, wherein the non-fluorinated melt processible polymer comprises at least one of polypropylene, polyethylene, and combinations thereof.

25. (canceled)

26. (canceled)

27. (canceled)

28. A method of forming an extrudate, the method comprising:
extruding the melt processible polymer composition according to claim 1.
